(19) United States
(12) Patent Application Publication
(10) Pub. No.: US 2018/0144142 A1
(43) Pub. Date: May 24, 2018

(54) Secure Data Protection and Encryption Techniques for Computing Devices and Information Storage

(71) Applicant: Sequitur Labs, Inc., Issaquah, WA (US)

(72) Inventors: Philip Attfield, Fall City, WA (US); Michael Doyle, Las Vegas, NV (US); Vincent Ting, Vancouver (CA)

(21) Appl. No.: 15/568,407

(22) PCT Filed: Apr. 25, 2016
(86) PCT No.: PCT/US16/29144

§ 371 Date: Oct. 20, 2017

Related U.S. Application Data
(60) Provisional application No. 62/153,671, filed on Apr. 28, 2015.

(51) Int. Cl. G06F 21/60; H04L 9/14; H04L 9/30; H04L 9/32

(52) U.S. Cl. CPC G06F 21/602; H04L 9/14; H04L 9/30; H04L 2209/80; H04L 9/3263; H04L 9/3247; H04L 9/3226

(57) ABSTRACT

A system for secure data protection and encryption for computing devices. The present invention includes a fast encryption technique for quickly ensuring that the correct binding parameters are used for an encrypted data file. The encrypted file is used in two ways. Because unsecure data could pass through a peripheral device to gain access to a secure computing environment, a dongle housing encryption and decryption subsystems is placed in between the unsecure sources and the peripheral that can encrypt and decrypt data intended for the secure computing environment. The firmware of the computing device can be updated by dividing the update file into encrypted segments that are verified on the device and placed into non-volatile memory. When all parts have been received, decrypted, and written into memory, the device reboots using the updated firmware.

### PRIORITY CLAIM

This non-provisional application claims priority to Provisional Patent Application Ser. No. 62/153,671, entitled “Secure Data Protection and Encryption Techniques for Computing Devices and Information Storage” filed Apr. 28, 2015.

### TECHNICAL FIELD

The present invention relates to the technical fields of Computer Security, Embedded Systems, Encryption, Mobile Computing, Telecommunications, Digital Communications, and Computer Technology.

### BACKGROUND OF THE INVENTION

Recent years have brought the emergence and rapid proliferation of mobile computing devices such as mobile telephones or “handsets” with extensive computing, communication, and input and interaction capabilities (“smart phones”) plus a growing array of other mobile computing devices such as touchscreen tablets, “netbooks”, electronic document readers, and laptops in a wide range of sizes and with wireless and wired communication capabilities.

This proliferation of mobile devices has been accompanied by complementary advances in development and adoption of long range wireless broadband technologies such as 3G and 4G, as well as commonplace deployment of shorter range wireless technologies such as the 802.11 series of wireless standards and “Bluetooth” short range wireless, all with considerable bandwidth. These technologies span multiple radio frequency bands and protocols.

Alongside the radio transceivers for such communications capabilities, many of these mobile devices also contain an array of onboard sensors such as cameras, microphones, and GPS receivers plus other locating technologies, as well as considerable fixed-onboard and removable memory for information and multimedia storage.

Furthermore, smartphones and similar devices are typically capable of running a wide variety of software applications such as browsers, e-mail clients, media players, and other applications, which in some cases may be installed by the user. Mobile devices are now fully capable computing environments that require security to the same extent as any other computing environment would.

Along with the profusion of smartphones and other mobile, wireless-capable devices, there has also been a dramatic increase in the use of social networks and related technologies for information sharing for consumer as well as for professional uses. Access to social networks on mobile devices has heightened concerns about individual, government, and corporate information security, and about possibilities for privacy violations and other unintended and undesirable information sharing. Furthermore, the possible professional and personal use of any given handset presents a complex set of usage contexts under which rules for device capability usage and information access need be considered.

Such sophisticated and capable smartphones and similar devices, along with the vast amounts of information that they can contain and access, present a large set of potential security vulnerabilities (a large “attack surface”) that might allow information to be accessed by malicious parties or allow undesirable use and exploitation of the device capabilities for malicious purposes such as “phishing” fraud, other online fraud, or inclusion in botnets for spam transmission, denial-of-service attacks, malicious code distribution, and other undesirable activities.

Furthermore, compared with conventional desktop personal computers, smartphone handsets by nature are portable and thus more easily stolen. Portability also means that the devices will encounter security contexts that cannot be foreseen, and which may never occur again. The mobile threat landscape is complex and presents a vast set of extant and emergent security concerns.

There is, therefore, a growing need to improve upon not only the degree of protection provided by components and systems that enhance the security of mobile devices, but also to improve on the efficiency and security of such security-related components and systems themselves, so that both they and the devices and the information that they protect are more robust and are better able to withstand attempts to thwart or otherwise compromise them.

### BRIEF SUMMARY OF THE INVENTION

Because modem mobile systems must connect to external (peripheral) devices and they must also be able to update their firmware and other executable programs in a secure manner, the present invention is an efficient system and method to encrypt files for transmission, and then either pass them securely through peripheral devices or directly to the firmware memory for updating. There are three key steps presented. The encryption is made more efficient by appending a small data segment to the end of the encrypted file to ensure that the binding parameters being used are correct. Peripherals are connected to the system via a dongle for encrypting or decrypting files that pass through the peripheral device that sits between the secure and normal operating environments. Finally, the invention proposes a system and method to securely update firmware or other executable programs to secure memory by segmenting the update file into signed and encrypted parts that are transmitted separately. They are then received, decrypted, and written to a secure memory location. When complete the system reboots (restarts) with the new updated firmware or executable program.

The invention has a number of advantages. The encryption method is more efficient than conventional methods because it is able to ensure that the best binding parameters are used. The dongle then uses the encryption technique to ensure that the inherent vulnerability of unsecure data reaching the secure world via peripheral devices is closed. All data is now encrypted. Lastly, the encryption technique is applied to each data segment of the firmware update or executable program to be written to ensure that the data that reaches the secure memory location is verified.

### BRIEF DESCRIPTION OF THE DRAWINGS

FIG. 1. Schematic representation of system.

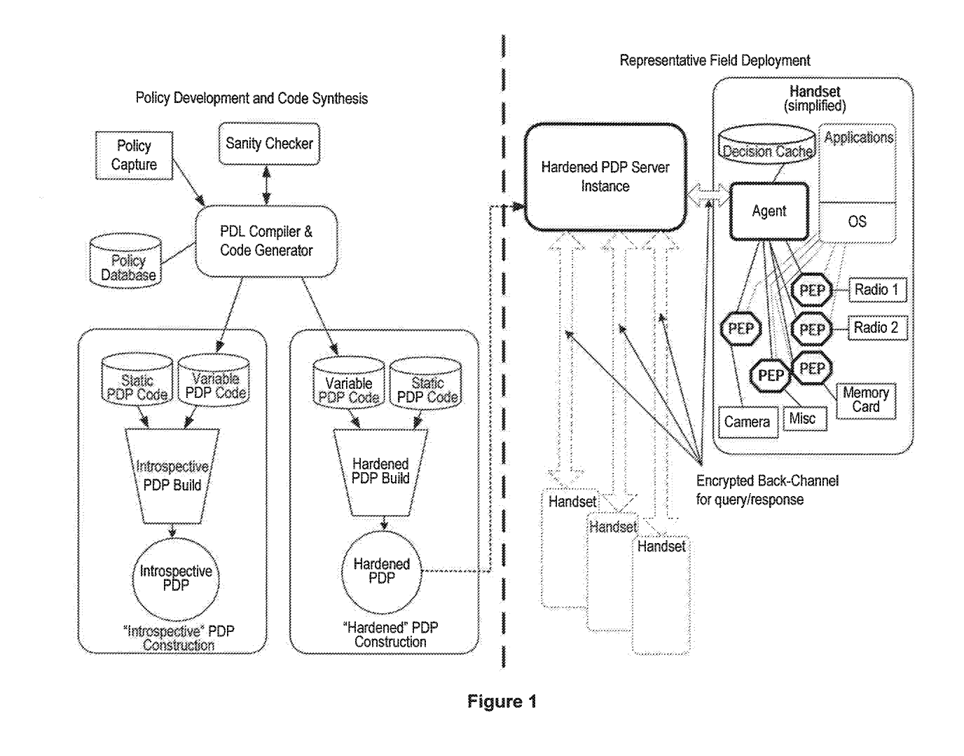

FIG. 2. The process of fast encryption and decryption for secure binding.

FIG. 3. The system for securing the pathway between the secure and normal world by placing a dongle in between the peripherals and the host.

FIG. 4. The process for secure firmware updates by segmenting the update, encrypting, transmitting, decrypting, and writing to a secure memory location.

### DETAILED DESCRIPTION OF THE INVENTION

The present invention consists of a set of capabilities and techniques for enhancing the security and privacy of information storage on computing devices, and for performing secure updates to network-connected computing devices.

### Encryption Techniques for Secure Binding and Fast Decryption Processing

Security of encryption of digital data for mobile devices can be enhanced by binding the encryption key to one or more specific digital objects, such that it is difficult or impossible to decrypt the data without the presence of, and access to, those objects. As a non-limiting example, such binding may be performed through the use of some complex computation with inputs that include each of the digital objects to be bound to, and with one of the outputs being the encryption key. In the following list, a set of such objects is presented which may be used in some combination to perform such secure binding:
Program or module binding.
Program version or module version binding.
Developer certificate binding
Device binding. In the case of device binding, the computed key is based on a parameter or on parameters unique to the device, such as the International Mobile Station Equipment Identity (IMEI), such that the encrypted file can only be decrypted on the same device.
Custom: allows the use of a custom parameter as an input to which to bind the key.
Password: allows the use of a password as an input to which to bind the key.

The set of objects used for binding can be a combination of these listed objects, as selected prior to or during binding.

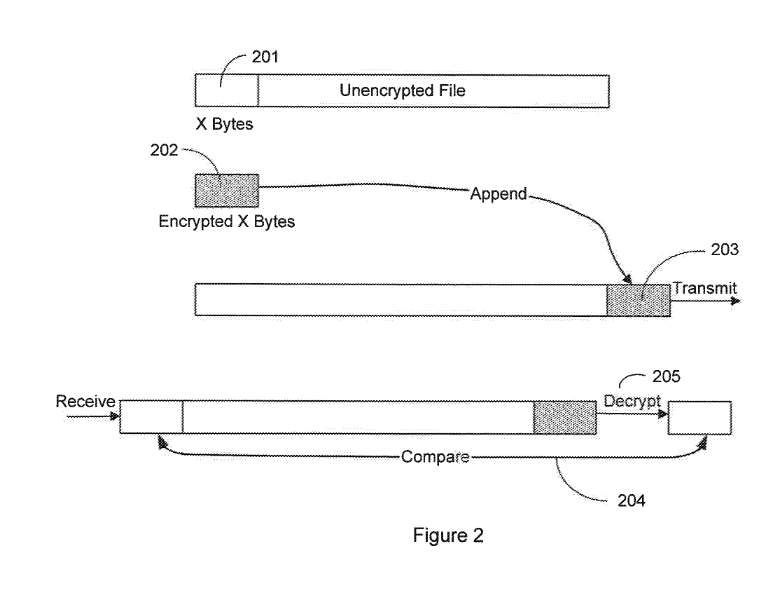

Among the drawbacks to encryption, and particularly to public key encryption over symmetric encryption, are the computational time and computational expense required for decryption of the encrypted data (FIG. 2). Furthermore, in some cases, it may not be known with certainty that the binding parameters about to be used for decryption are the correct ones. Steps can be taken during encryption to allow for faster processing when the file is later decrypted. As one such step, a small segment of a certain initial segment of the unencrypted file (201) is copied, pre-processed and encrypted (202), then finally appended to the end of the encrypted file (203). That segment, rather than the whole file, can then be examined post-encryption to determine whether the binding parameters to be used in decryption are the correct ones (204).

As a specific, non-limiting example, during the encryption process, the Secure Hash Algorithm SHA256 is applied to a copy of the first X bytes (201) of the unencrypted file and the encrypted copy is appended to the whole file, encrypted (202), to the end of the encrypted file (203). After this procedure, post-encryption, unencrypt and extract the appended SHA256 component (205) and compare it with the first X bytes (204), and verify that they match, as a fast test that the binding parameters being used in the decryption are correct.

### Methods for Securing Peripherals

One key approach to defending security-related systems, data, and components from malicious attack is to have them reside within especially secure areas, partitions, or environments on device hardware that are inaccessible to unauthorized parties or for unauthorized purposes, with this “secure world” separated from the main device operating system and, in some cases, from certain of its insecure resources, with these insecure components comprising the “normal world”. A further degree of security can be provided if the secure partitions or areas are also invisible and undetectable to the greatest degrees possible, under unauthorized circumstances and by unauthorized parties.

However, even with the use of such secure areas and other measures internal to the computer, due to a need for interaction and input with computer users in many cases, weak points for security of entire systems remain, such as the input and output devices themselves, and their connections and interfaces with other system components and with operating system software and applications. Malicious use of software for intercepting keyboard entries, or “key logging”, is common, as is “phishing” software for unwanted interception of entered data, and this represents a considerable threat that can reveal passwords and other sensitive data to parties not intended to see it.

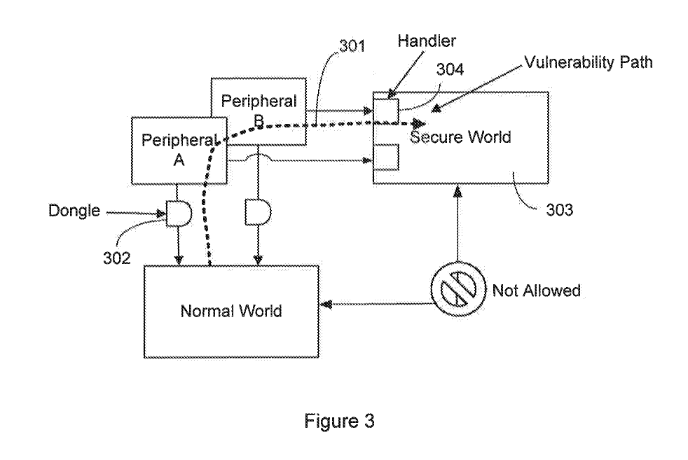

In the present invention (FIG. 3), the following means provide for more secure coupling of input and output devices to secure system components and applications on a host computer. Here, secure transmission of data to or from a peripheral device is provided through a “normal” or untrusted partition or channel, from or to a secure partition or secure area on the host, and with the data securely protected during its passage (301). Non-limiting examples of such peripherals include keyboards, keypads, trackpads, touchscreens, mice, camera, biometric sensors, active display devices such as LCD displays and monitors, printers, and plotters. In order to do this, a hardware device hereinafter referred to as “dongle”, containing certain required components is inserted or installed between the peripheral and the host (302).

Connections between peripheral, dongle, and host may be through standard interfaces such as USB, PS/2, or by other means, but in each case with the dongle securely separating peripheral and host. The components include storage for digital encryption key(s) as needed for encryption of data prior to transmission, as well as required hardware for interfacing with the input device and the computer. This allows for data to be encrypted before transmission to the normal world of the host for passage through to the secure world for use in secure or otherwise trusted applications there such as payment applications or healthcare-related applications. Corresponding encryption keys are stored in the secure world (303) for appropriate encryption data as needed for communication with the secured peripherals. Each secured peripheral has a corresponding “handler” module (304) in the secure world for managing communication out into the normal world through to the peripheral.

In some cases, peripheral input and output cannot be communicated directly to a secure world, and in such cases, a normal world application may be required as an intermediary to route traffic from the input device such as a keyboard, to a trusted application for processing, but in such a case the data is already encrypted prior to reaching the intermediary. Similarly, output to a display device could be done using an intermediary normal world application driving a GPU, but with though the normal world to a display being encrypted by an intermediary dongle.

In cases where such secure communication with the peripheral is not required, the dongle is permitted to go into a non-encrypting mode and act as a transparent “pass through” of unencrypted or otherwise unsecured data to a normal world unsecured application, upon receipt of an acceptable signal such as a key sequence or special key code from the user.

### Methods for Secure Device Firmware Updates

Modem computing devices such as smartphones, tablet computers, and also internet-connected devices in the “Internet of Things”, typically contain non-volatile memory and persistent memory content collectively known as “firmware” that is stored in the non-volatile memory on the device. Firmware content may include operating system code, “boot loader” code for device initialization and loading the operating system, and other code essential to device operations, plus data and in some cases application software.

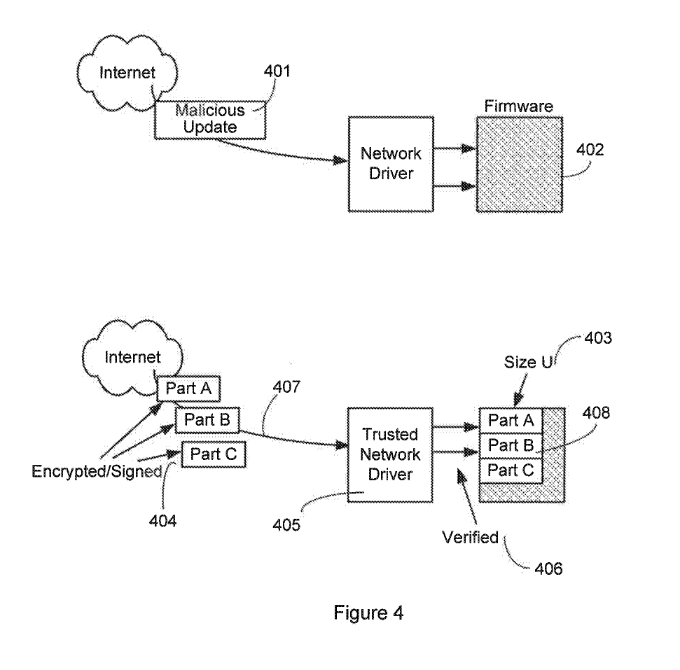

Inevitably, whether to fix software bugs, patch security vulnerabilities, to update features, or for other reasons, it is desirable to be able to update the firmware content. For reasons such as lower cost, manageability, and ease of update, it can be preferable to update the firmware via the internet or some other network connection, rather than by other means such as hardware replacement or by transfer of the new firmware content from a locally connected storage device. However, such “Over the Air” (OTA) network updates present certain security risks such as possible malicious interception of the in-transit firmware and subsequent injection of malicious code onto the device (401), or other undesired exploits of firmware target content (402). The following methods are presented for securing such firmware updates (FIG. 4).

First, the method requires that at least some amount of size U of non-volatile memory (403) be designated for use for the secure updating process. The new firmware of the update, the net “payload” in this case, is encrypted that can be securely verified on the target device, and split into data segments of size U or smaller (404). Each segment is digitally signed. A secure other portion of non-volatile memory such as a locked “boot” portion must contain trusted drivers (405) for network connections such as wired internet or wireless technology such as 802.11 variants or cellular, and/or other network modalities, and that portion or another locked portion should contain certificates or root certificates as required to decrypt received segments of encrypted payload. The means to call cryptographic verification functions should also either reside in or have its driver in the boot sector (406).

Data segments are then transmitted over the network (407) from a secure server or other secure source and received via the trusted network driver (405) and used to update other non-volatile memory areas appropriately. Data segments may be received sequentially and loaded into successive non-volatile memory locations in received order, or in other cases may be loaded in any sequence and may be loaded into assigned non-volatile memory locations designated for individual identified segments; these and other segment transmission possibilities are contemplated within the invention. As each data segment is received, its signature is verified (406), and the data segment is written to the appropriate portion of non-volatile memory (408). The download, verify, install procedure of data segments is repeated until the entire set of segments, comprising the update payload is received. Once entire set of data segments has been installed into memory, the device can boot (restart) with the newly updated firmware. Note that this procedure is not exclusive to firmware updates but can be used to safely write any executable program into secure memory.

This method has the strengths or advantages as follows:
1) The network driver used for OTA updates is trustworthy regardless of device state. This is important because if the device is in a partially-updated state, then a trustworthy loader is required throughout uploading for confidence of fully secure update and for secure recovery to be possible in case of failed transmission of any chunks or in case of any other update problems.
2) A reliable fallback mechanism exists in that a partially-updated device can still boot with network connectivity because the driver and ability to check payload reside in a trusted area.

### INDUSTRIAL APPLICATION

The invention is generally useful to any application where the computing device used may be connected to external peripheral devices and must be updated periodically. Neither the firmware update technique nor the peripheral dongles require the use of the aforementioned encryption technique but some accepted form of encryption must be employed. Any computing device can use these techniques, not only mobile or handheld devices.

What is claimed is:

1. A system for secure data protection for computing devices each having non-volatile secure memory and that communicate with peripheral devices configured to accept data from unsecure sources and to transmit data to the non-volatile secure memory comprising:
a fast encryption subsystem for efficiently encrypting data;
a fast decryption subsystem for efficiently decrypting data from the fast encryption subsystem and for ensuring that the correct binding parameters are used;
a dongle for housing a peripheral security subsystem having the fast encryption subsystem and the fast decryption subsystem for encrypting and decrypting data that passes through the peripheral devices to and from, respectively, the non-volatile secure memory.

2. A system for secure data protection and updating for computing devices each having non-volatile secure memory and that communicate with peripheral devices configured to that accept update data from unsecure sources and to transmit update data to the non-volatile secure memory comprising:
a fast encryption subsystem for efficiently encrypting update data, said update data being data that includes an executable program;
a fast decryption subsystem for efficiently decrypting update data from the fast encryption subsystem and for ensuring that the correct binding parameters are used;
a dongle for housing a peripheral security subsystem having the fast encryption subsystem and the fast decryption subsystem for encrypting and decrypting update data that passes through the peripheral devices to and from, respectively, the non-volatile secure memory; and
a secure updating subsystem for securely updating software executable programs stored in the non-volatile secure memory on the computing device.

3. The system of claim 1, wherein the fast encryption subsystem includes:
a segmentation subsystem for dividing the unencrypted data into separate data segments each of which are less than a preselected byte size;
a binding subsystem for binding the encryption key to an object;
an encryption subsystem for encrypting all of the data segments and for appending a copy of the first encrypted segment to the end of the series of encrypted segments; and
a transmission subsystem for transmitting the encrypted data segments with the appended data segment to the non-volatile secure memory.

4. The system of claim 1 wherein the fast decryption subsystem includes:
a receiver subsystem for receiving encrypted data segments from the fast encryption subsystem;
a trusted network driver coupled to the receiver subsystem for ensuring that all the encrypted data segments are received from a trusted source and for recomposing the data segments in original order;
an extraction subsystem for extracting and decrypting the last data segment and for comparing it to the decrypted first data segment for ensuring that the correct binding parameters are used;
a verifier for decrypting the encrypted data segments and for verifying the authenticity of the data segments and for writing the decrypted data segments into the non-volatile secure memory.

5. The system of claim 3 wherein the encryption subsystem digitally signs each of the encrypted data segments.

6. The system of claim 3, wherein the object that the encryption key is bound to includes at least one of:
a program module;
a program version;
a developer certificate;
a device;
a password; and
a custom binding defined by the user.

7. The system of claim 1, wherein the peripheral security subsystem includes:
a dongle for each peripheral device having a fast encryption subsystem and a fast decryption subsystem housed therein for encrypting and decrypting data that passes through peripheral devices to and from the non-volatile secure memory; and
a handler within the non-volatile secure memory associated with each peripheral device for managing communication to and from the unsecure environment into the non-volatile secure memory via that peripheral device.

8. The system of claim 2, wherein the secure updating subsystem includes:
a network interface for reading unencrypted update data from an external source;
a segmentation subsystem for dividing the unencrypted update data into separate unencrypted update data segments each of which are less than a preselected byte size;
an encryption subsystem for encrypting all of the update data segments and for appending a copy of the encrypted first update data segment to the end of the series of encrypted update data segments;
a transmitter for transmitting the encrypted update data segments to the non-volatile secure memory via the network;
a trusted network driver for ensuring that the encrypted update data segments are received from a trusted source;
a verifier for decrypting the encrypted update data segments, for comparing the decrypted last update data segment to the first decrypted update data segment to ensure that the correct binding parameters are used, for verifying the authenticity of the update data segments, and for writing the decrypted update data segments into the non-volatile secure memory in their original order; and
a restart subsystem for restarting the software executable program within the non-volatile secure memory.

9. The system of claim 8, wherein the encryption subsystem further digitally signs each update data segment.

10. A method for secure data protection for computing devices each having non-volatile secure memory and that communicate directly with peripheral devices that accept data from unsecure sources and transmit data to the non-volatile secure memory comprising the steps of:
inserting a dongle having a fast encryption subsystem and a fast decryption subsystem housed therein between each peripheral device and each unsecure source for fast encrypting and decrypting of data;
segmenting the unencrypted data from the unsecure source into separate unencrypted data segments each of which are less than a preselected byte size and encrypting each data segment;
transmitting each encrypted data segment to the non-volatile secure memory;
decrypting each encrypted data segment within the non-volatile secure memory; and
recomposing the decrypted data by sequencing the data segments in original order.

11. A method for secure data protection and updating for computing devices each having non-volatile secure memory and that communicate directly with peripheral devices that accept update data from unsecure sources and transmit update data to the non-volatile secure memory comprising the steps of:
inserting a dongle having a fast encryption subsystem and a fast decryption subsystem housed therein between each peripheral device and each unsecure source for fast encrypting and decrypting of update data;
segmenting the unencrypted update data from the unsecure source into separate unencrypted update data segments each of which are less than a preselected byte size and encrypting each update data segment;
transmitting each encrypted update data segment to the non-volatile secure memory;
decrypting each encrypted update data segment within the non-volatile secure memory;
recomposing the decrypted update data by sequencing the update data segments in original order, and
restarting the executable program with the new update after all update data segments have been received and recomposed.

12. The method of claim 10 wherein the fast encryption of data includes the steps of:
binding an encryption key to an object;
creating a copy of an unencrypted data segment of a preselected byte size from the beginning of the data to be encrypted;
encrypting the copy of the unencrypted data segment using an encryption process;
encrypting all of the other unencrypted data segments;
appending the encrypted copy of the first data segment to the end of the encrypted data segments; and
transmitting the complete encrypted file.

13. The method of claim 10 wherein the fast decryption of data includes the steps of:
receiving the encrypted file;
extracting the appended encrypted copy of the first data segment from the end of the encrypted file;
decrypting the encrypted copy of the first data segment;
comparing the decrypted copy of the first data segment with the unencrypted first data segment from the beginning of the encrypted file for identifying the correct binding parameters; and
decrypting all of the other encrypted data segments using the correct binding parameters.

14. The method of claim 10 wherein secure data protection for computing devices further includes the steps of:
intercepting data from the non-volatile secure memory intended for use in an unsecure computing environment using the dongle; and
decrypting the data using the dongle for use in the unsecure computing environment.

15. The method of claim 10 wherein secure data protection for computing devices further includes the steps of:
intercepting data from an unsecure computing environment intended for use in the non-volatile secure memory using the dongle;
encrypting the data using the dongle for use in the non-volatile secure memory; and
verifying the data passed into the non-volatile secure memory with a handler for decrypting data.
